(19) United States
(12) Patent Application Publication
(10) Pub. No.: US 2024/0405657 A1
(43) Pub. Date: Dec. 5, 2024

(54) FEEDBACK CIRCUIT WITH ADJUSTABLE LOOP GAIN FOR A BOOST CONVERTER

(71) Applicant: GOODIX TECHNOLOGY (HK) COMPANY LIMITED, Hong Kong (CN)

(72) Inventors: Bernardus Henricus KRABBENBORG, Nijmegen (NL); Jokin SEGUNDO BABARRO, Nijmegen (NL); Marco BERKHOUT, Nijmegen (NL)

(73) Assignee: GOODIX TECHNOLOGY (HK) COMPANY LIMITED, Hong Kong (CN)

(21) Appl. No.: 18/737,636

(22) Filed: Jun. 7, 2024

Related U.S. Application Data
(63) Continuation of application No. PCT/CN2022/136160, filed on Dec. 2, 2022.

(30) Foreign Application Priority Data
Dec. 9, 2021 (EP) 21213515.6

(51) Int. Cl. H02M 1/00; H02M 3/158

(52) U.S. Cl. CPC H02M 1/0025; H02M 3/158

(57) ABSTRACT

A feedback circuit for a boost converter wherein the feedback circuit comprises a measurement resistance R_{M} configured to receive a current I_{COIL} from the boost converter, a feedback resistance R_{SH}, a gain circuit g_{M} comprising a gain output and configured to receive a sensed voltage associated to the measurement resistance, and to provide, at the gain output, a gain signal generated based on the sensed voltage; and a comparison circuit comprising a comparison output, and configured to generate a comparison signal, at the comparison output, wherein the comparison signal is generated based on the gain signal, a voltage drop across the feedback resistance R_{SH} and a reference signal V_{REF}.

### CROSS-REFERENCE TO RELATED APPLICATIONS

This application is a continuation of International Application No. PCT/CN2022/136160, filed on Dec. 2, 2022, which claims priority to EPO patent application Ser. No. 21/213,515.6, entitled “Feedback circuit with adjustable loop gain for a boost converter” and filed on Dec. 9, 2021. The disclosures of the aforementioned applications are hereby incorporated by reference in their entireties.

### TECHNICAL FIELD

The disclosure relates to a feedback circuit for a boost converter with adjustable loop gain. The disclosure further relates to a boost converter circuit comprising the feedback circuit with adjustable loop gain and to a method of operating the feedback circuit with adjustable loop gain.

### BACKGROUND

Energy harvesting is the process by which energy is derived from external sources, captured, and stored for small, wireless autonomous devices, like those used in wearable electronics and wireless sensor networks. A direct current to direct current ‘DC-to-DC’ converter circuits, such as boost converter circuits, are electronic circuits that convert a source of direct current (DC) from one voltage level to another voltage by first charging an energy storage element using an input voltage and then discharging the energy storage element to provide the energy at the output of the DC-to-DC converter. DC-to-DC converters can be used to increase the amount of energy harvested from an energy source. Constant-On-Time (COT) boost converters are popular for its simplicity and high performance in both continuous conduction mode (CCM) and discontinuous conduction mode (DCM). COT boost converters use feedback circuits to control the switching of the boost circuit. These feedback circuits need to comply with certain stability requirements in order to work properly. As the stability criteria depends on the value of some of the components of the boost converter circuit for a given target output voltage, the stability criteria is met at the price of efficiency and/or costs.

Xiaoru Xu, Xiaobo Wu, Xiaolang Yan, “A Quasi Fixed Frequency Constant On Time Controlled Boost Converter,” IEEE International Symposium on Circuits and Systems, ISCAS 2008, discloses a COT boost converter circuit wherein, for a given battery voltage VBAT as input, a given inductor L_{BST} and a given target current I_{LOAD}, a requirement for stability contradicts with requirements for cost, i.e. a low value of the capacitor C_{BST} at the output, and efficiency, i.e. a low value of the measurement resistor R_{M}). I.e., stability can only be reached at expenses of efficiency or cost. An obvious way to prevent the contradictory requirements is the use a different kind of converter topology, but that eliminates all the simplicity and performance advantages of the COT topology.

Jinping Wang, Liangkui Hou, Liang Zhang, Sheng Xiang, and Yigang He, “Analysis of the Low-frequency Oscillation Phenomenon in Constant-on-time Controlled Boost Converter”, IEEE Energy Conversion Congress and Exposition, ECCE 2015 discloses a method that consists on relocating the measurement resistance R_{M} of the feedback circuit in series with the output capacitor C_{BST}. In this way, the dissipation is moved to the output capacitor C_{BST}. However, this does not improve efficiency and makes the stability dependent on the parasitic of an external component, i.e. on the output capacitor C_{BST}. Moreover, the stability requirements still depend on the measurement value of the resistance R_{M}. Furthermore, this configuration also introduces a high unwanted ripple on the output voltage V_{BST}.

It would be advantageous to implement a low cost efficient feedback circuit for a boost converter circuit that still meets the required stability criteria.

### SUMMARY

An object of the disclosure is to implement a stable boost converter circuit in an efficient and cost-effective way.

The disclosure relates to a feedback circuit for a boost converter circuit wherein the feedback circuit comprises a measurement resistance R_{M} configured to receive a current Icon from the boost converter, a feedback resistance R_{SH}, a gain circuit g_{M} comprising a gain output and configured to receive a sensed voltage associated to the measurement resistance, and to provide, at the gain output, a gain signal I_{M} generated based on the sensed voltage; and a comparison circuit comprising a comparison output, and configured to generate a comparison signal, at the comparison output, wherein the comparison signal is generated based on the gain signal, a voltage drop across the feedback resistance R_{SH} and a reference signal V_{REF}. In this way, the gain circuit introduces a gain at the comparison circuit which allows to meet the required stability criteria in an efficient and simple way. This allows to extend the load current range for a constant-on-time boost converter circuit beyond the limits normally dominated by external components, battery voltage and switch resistance. This means that the maximum load current can be increased to levels where a conventional converter would not be stable, or would need a higher measurement resistance value by choosing a high Effective Series Resistance (ESR) in the output capacitance, resulting in power loss and high ripple voltage, or a high switch resistance resulting in high power losses, or would need a higher output capacitance value, or would need a lower inductor value resulting in higher ripple current amplitude. Furthermore, the gain setting can be used to optimize the balance between cost (external capacitance), efficiency (measurement resistance, ESR), performance (output resistance, ripple voltage, ripple current) and for a given use case (load current, battery voltage). Also the use of capacitor in the feedback circuit is prevented such that the feedback circuit can be smaller compared to a feedback circuit using a capacitor suited for the whole voltage range.

The measurement resistance R_{M} may comprise a first end and a second end, the gain circuit may comprise a first gain input and a second gain input and wherein the gain circuit may be configured to receive, at the first gain input, a first voltage sensed at the first end of the measurement resistance, to receive, at the second gain input, a second voltage sensed at the second end of the measurement resistance, and to provide, at the gain output, the gain signal I_{M} generated based on the first sensed voltage and the second sensed voltage. This is a suitable way to connect the gain circuit such that the gain can be provided at the inputs of the comparison circuit in an efficient way.

The feedback resistance R_{SH} may comprise a first end and a second end and wherein the first end of the feedback resistance R_{SH} may be coupled to the second end of the measurement resistance, the second end of the feedback resistance (R_{SH}) may be coupled to the comparison circuit and the gain output may be coupled to the comparison circuit. Again, this allows for providing the gain at the inputs of the comparison circuit in an efficient way.

The comparison circuit may comprise a first comparison input, a second comparison input and a comparison output, wherein the comparison circuit may be configured to receive the reference voltage at the first input, to receive a feedback signal at the second input, and to generate the comparison signal by comparing the feedback signal and the reference signal, wherein the feedback signal may be based on the gain signal and the voltage drop across the feedback resistance. This provides the gain at the input of the comparison circuit in a suitable and efficient manner, thereby saving in resources.

The gain output may be coupled to the second end of the feedback resistance and to the second comparison input. This is a suitable manner of connecting the gain output to provide the gain at the input of the comparison circuit.

The feedback circuit may comprise another feedback resistance configured to receive the gain signal wherein the comparison circuit may comprise a first comparison input, a second comparison input and a comparison output, wherein the comparison circuit is configured to receive, at the first comparison input, the sum of the reference voltage and a further voltage drop caused by the gain signal across the another feedback resistance, to receive the voltage drop across the feedback resistance R_{SH} at the second comparison input and to generate the comparison signal by comparing the sum of the reference voltage and the further voltage drop with the voltage drop across the feedback resistance R_{SH}. This allows to provide the gain to the circuit independently of the value of R_{SH}.

The another feedback resistance may comprise a first and a second end wherein the first comparison input may be coupled to the first end of the another feedback resistance and to the gain output and wherein the second end of the another feedback resistance may be coupled to the reference voltage.

The gain circuit may comprise a voltage controlled current source. This is a suitable implementation of the gain circuit.

The first end of the feedback resistance R_{SH} may be coupled to an output terminal V_{BST} of the boost converter.

The feedback circuit may further comprise a measurement switch SM wherein the measurement switch S_{M} and the measurement resistance R_{M} may be coupled in series, wherein the measurement switch S_{M} and the measurement resistance R_{M} may be coupled in parallel with a first switch S_{H} of the boost converter, wherein the first switch S_{H} comprises an on-resistance RH when the first switch S_{H} is closed, and wherein the measurement switch S_{M} and the first switch S_{H} of the boost converter circuit may be configured to open and close at the same time. This allows to reduce dissipation at the output because prevents energy loss at the measurement resistance by re-using the on-resistance R_{H} of the switch S_{H} which is present anyway. The measurement R_{M} is no longer in the high current path, and with an additional switch S_{M}, that switches simultaneously with switch S_{H}, the voltage across the switch S_{H} and the on-resistance R_{H} is sensed when both switches S_{H} and S_{M} are closed. The measurement resistance R_{M} can now be chosen much larger so that the power loss in the measurement resistance R_{M} can be neglected.

The feedback circuit may further comprise an adjustable current source coupled to the second end of the feedback resistance and to the second comparison input of the comparison circuit. This is a suitable way of adjusting the voltage at the output to the required value. Alternatively, the feedback circuit may comprise a current DAC controlled by a digital word or a voltage controlled current source controlled by a control voltage or a current controlled current source controlled with a control current.

The disclosure also relates to a boost converter circuit comprising a feedback circuit.

The disclosure relates as well to a method of operating a feedback circuit for a boost converter circuit.

The person skilled in the art will understand that the features described above may be combined in any way deemed useful. Moreover, modifications and variations described in respect of the system may likewise be applied to a method.

### BRIEF DESCRIPTION OF THE DRAWINGS

In the following, aspects of the disclosure will be elucidated by means of examples, with reference to the drawings. The drawings are diagrammatic and are not drawn to scale.

FIG. 1 shows a known boost converter circuit.

FIGS. 2A-B and 3A-B show diagrams of time waveforms of several signals of the boost converter circuit of FIG. 1 during operation.

FIG. 4 shows a feedback circuit according to an embodiment of the disclosure.

FIG. 5 shows a boost converter circuit comprising the feedback circuit of FIG. 4.

FIG. 6 shows another feedback circuit according to another embodiment of the disclosure.

FIG. 7 shows a boost converter circuit comprising the feedback of FIG. 6.

FIG. 8 shows a boost converter circuit comprising a feedback circuit according to another embodiment of the disclosure.

FIGS. 9A-B show time diagrams of the waveforms of several signals of the boost converter circuit 800 of FIG. 8 during operation.

FIGS. 10 and 11 show examples of implementations of the boost converter circuit of FIG. 8.

FIG. 12 shows a flowchart of a method of operating the feedback circuit for a boost converter circuit of FIG. 6.

### DESCRIPTION OF EMBODIMENTS

In the figures, the same reference numbers indicate elements that are similar in structure and function.

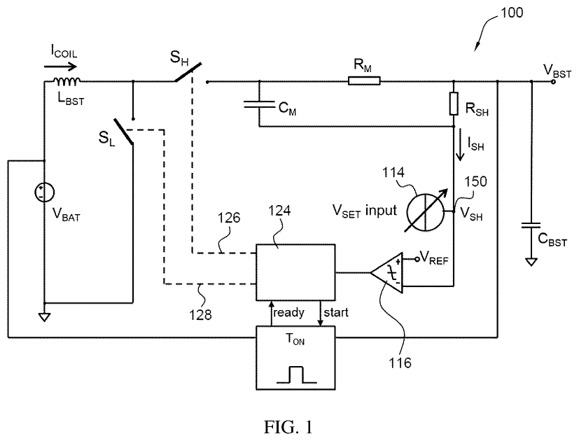

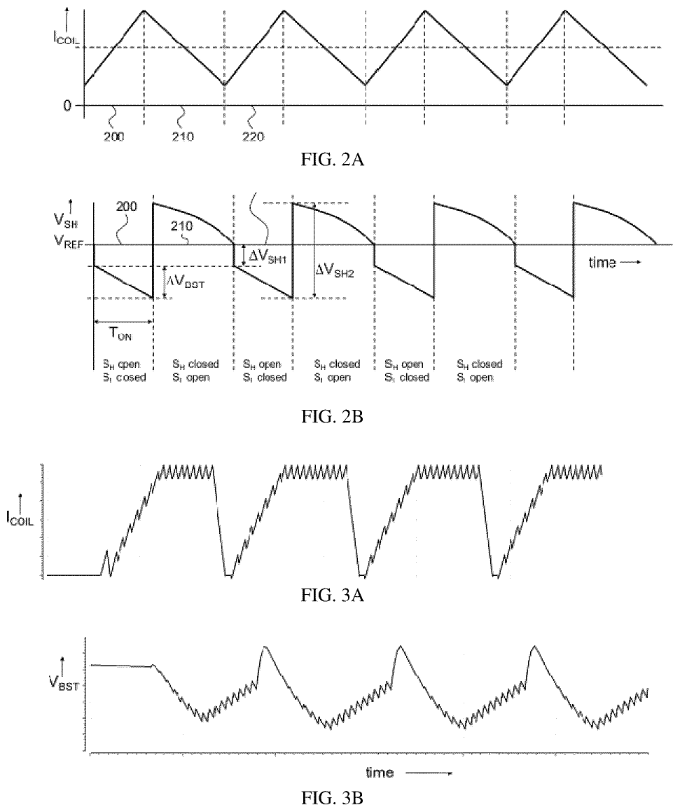

FIG. 1 shows a known boost converter circuit 100. FIGS. 2A-B and 3A-B show diagrams of time waveforms of several signals of the boost converter circuit of FIG. 1 during operation. The operation of a boost converter circuit will be now explained with reference to FIGS. 1, 2A-B, and 3A-B. FIGS. 2A-B illustrates the ideal values of V_{SH}, and I_{COIL} as a function of time for the different operation states of the boost converter circuit of FIG. 1. FIGS. 3A-B illustrate the real values of V_{BST}, and Icon as a function of time for the different operation states of the boost converter circuit of FIG. 1. The I_{COIL} is the current through the inductor L_{BST}. As it can be seen in FIGS. 2A-B, during the time interval 200 the switch S_{L} is close and the switch S_{H} is open in order to connect the inductor L_{BST} to the ground as it can be seen in FIG. 1. When the inductor L_{BST} is connected to ground, the boost converter circuit enters into a charging state in which current flows through the inductor L_{BST} and the inductor L_{BST} stores some energy by generating a magnetic field. The current I_{COIL} in the inductor L_{BST} increases during the time interval 200 as it can be seen in FIG. 2A. A control unit 124 sends a control signal 128 to open the switch S_{L} in order to disconnect the inductor L_{BST} from the ground, and a control signal 126 to close the switch S_{H} in order to connect the inductor L_{BST} to the output V_{BST} via a measurement resistor R_{M} as it can be seen in FIG. 1 and the boost converter circuit enters into a discharging state in which, during the time interval 210, the energy previously accumulated in the inductor L_{BST} is transferred to the output V_{BST} therefore charging the capacitor C_{BST} and the current I_{COIL} in the inductor L_{BST} starts decreasing, as it can be seen in FIG. 2A. Time intervals 200 and 210 define in this case a continuous mode event wherein a completed switching cycle has been performed by the circuit. A new continuous mode event starts with time interval 220.

Although the above example has considered that the DCDC circuit worked in a in a continuous mode wherein the current at the inductor L_{BST} does not discharge to zero after each charging period, but it does discharge to a lower energy threshold, the circuit may be working in a DCM mode.

A target output boost voltage V_{BST} for the boost converter circuit of FIG. 1 is set by choosing an appropriate value for the current I_{SH} using the adjustable current source 114 as follows:

$${I}_{S H} = \frac{{V}_{B S T , T A R G E T} - {V}_{R E F}}{{R}_{S H}}$$

In the boost converter circuit of FIG. 1, the switch S_{L} is closed with a frequency f and a duty cycle D that depends on the output voltage V_{BST} and on the input voltage V_{BAT} in a periodic steady state condition with constant load as follows:

$$D = \frac{{V}_{B S T} - {V}_{B A T}}{{V}_{B S T}}$$

The on-time TON of the boost converter circuit of FIG. 1, i.e., the period of time 200, is related to the frequency f and the duty cycle D in the following way:

$$f = \frac{D}{{T}_{O N}}$$

This means that, for a fixed value of the on-time T_{ON}, the frequency f would depend on the duty cycle D, and therefore on both the input voltage V_{BAT} and the output voltage V_{BST}, which is generally not desirable. Therefore, the on-time T_{ON} is usually chosen to depend on the input voltage V_{BAT}, the output voltage V_{BST} and the intended switching frequency f_{TARGET} as indicated below:

$${T}_{O N} = \frac{{V}_{B S T} - {V}_{B A T}}{{f}_{T A R G E T} {V}_{B S T}}$$

The actual switching frequency f will be equal to the intended frequency f_{TARGET}, and independent of the input voltage V_{BAT} and the output voltage V_{BST} as follows:

$$f = \frac{D}{{T}_{O N}} = \frac{\frac{{V}_{B S T} - {V}_{B A T}}{{V}_{B S T}}}{{T}_{O N}} = \frac{\frac{{V}_{B S T} - {V}_{B A T}}{{V}_{B S T}}}{\frac{{V}_{B S T} - {V}_{B A T}}{{f}_{T A R G E T} {V}_{B S T}}} = {f}_{T A R G E T}$$

As it can be seen in FIGS. 2A-B and 3A-B, in a (periodic) steady state under constant load conditions, a step ΔV_{SH2} in a control voltage VHS at a control node 150 when the switch S_{H} is switched on or close must be high enough to bring a voltage V_{SH} above the chosen reference voltage V_{REF}. Otherwise the comparator 116 will not toggle and the boost converter circuit stops switching, as illustrated in FIGS. 3A-B. This will occur for high load currents with a large difference ΔV_{BST} between the highest and the lowest value output voltage V_{BST}. In this way, the boost converter circuit must satisfy the following stability condition:

$$Δ {V}_{B S T} < Δ {V}_{S H 2} - Δ {V}_{S H 1}$$

ΔV_{SH1} represents a step in the control voltage VHS at the control node 150 when the switch S_{H} is switched off or open. If we called I_{COIL,MIN} to the minimum current in the inductor L_{BST}, I_{COIL,MAX} to the maximum current in the inductor L_{BST}, and ΔI to the peak-peak ripple amplitude, i.e. to the difference between the minimum current I_{COIL,MIN} and the maximum current I_{COIL,MAX}·then the step ΔV_{SH1} and the step ΔV_{SH2} can be defined as follows:

$$\begin{matrix}Δ {V}_{S H 1} = {I}_{COIL , MIN} {R}_{M} \\ Δ {V}_{S H 2} = {I}_{COIL , MAX} {R}_{M}\end{matrix}$$

Wherein the above definitions of ΔV_{SH1} and ΔV_{SH2} leads to:

$${Δ V}_{SH 2} - {Δ V}_{SH 1} = Δ I {R}_{M}$$

The peak-peak ripple amplitude ΔI can be written as a function of the on-time T_{ON}, the input voltage V_{BAT} and the inductor L_{BST} as follows:

$$Δ I = \frac{{V}_{BAT}}{{L}_{BST}} {T}_{ON}$$

A load current I_{LOAD} and an output capacitance C_{BST} determine the voltage drop ΔV_{BST} of the output voltage V_{BST} during the on-time T_{ON} in the following way:

$${Δ V}_{BST} = \frac{{T}_{ON} {I}_{LOAD}}{{C}_{BST}}$$

In this way, the stability condition can be rewritten as:

$$\frac{{R}_{M} {C}_{BST} {V}_{BAT}}{{L}_{BST}} > {I}_{LOAD}$$

It can be seen and already said, in the boost converter circuit shown in FIG. 1, for a given inductor L_{BST} and a given input voltage V_{BAT}, the above stability criteria depends on the values of the measurement resistance R_{M} and the output capacitor C_{BST}. However, high values of the measurement resistance R_{M} implies high energy dissipation and therefore to an inefficient boost converter circuit, and output capacitor C_{BST} with a high value are expensive.

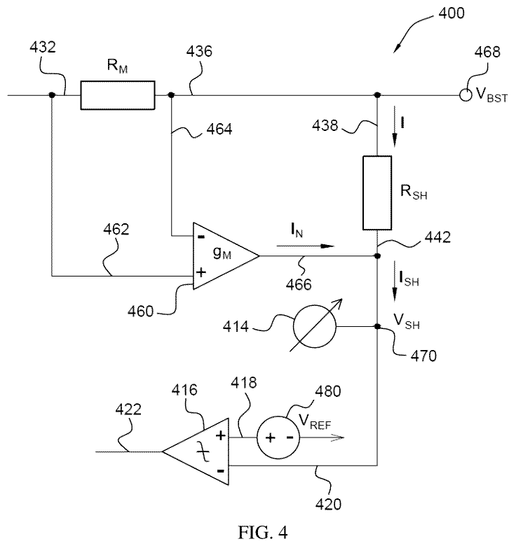

FIG. 4 shows a feedback circuit 400 according to an embodiment of the disclosure. The feedback circuit of FIG. 4 comprises a measurement resistance R_{M}, a feedback resistor R_{SH}, and an adjustable current source 414 configured to receive as an input a voltage VSET and to provide as output a current I_{SH} such that a voltage V_{SH} is adjusted to the required value VSET. The feedback circuit of FIG. 4 further comprises a comparison circuit 416 comprising a first comparison input 418, a second comparison input 420 and an comparison output 422 wherein the comparison circuit 416 is configured to receive from a voltage source 480 a reference voltage V_{REF} at the first comparison input 418, the voltage V_{SH} at the second comparison input 420 and to generate a comparison result at the comparison output 422 based on comparing the first comparison input 418 and the second comparison input 420. The feedback circuit of FIG. 4 may be further configured to send the comparison output 422 to a control circuit of a boost converter circuit (not shown in FIG. 4) such that the control circuit generates a control signal based on the comparison circuit in order to control the switching of the boost converter circuit.

The feedback circuit of FIG. 4 comprises also a gain circuit having a g_{M} stage and comprising a voltage controlled current source 460 comprising a first gain input 462 connected at a first end 432 of the measurement resistance, a second gain input 464 connected at a second end 436 of the measurement resistance and a gain output 466 configured to provide a current I_{M} based on voltage sensed at the first and second gain inputs. Furthermore, the feedback resistance R_{SH} comprises a first end 438 connected to the second end 436 of the measurement resistance and a second end 442 connected to the gain output 466, to the adjustable current source 414, and to the second comparison input 420.

In FIG. 4, the programmable current I_{SH} defines a target boost voltage at the output terminal 468 of the boost converter circuit. The target boost voltage is defined by:

$${V}_{BST , TARGET} = {V}_{REF} + {I}_{SH} {R}_{SH}$$

The voltage V_{SH} at the feedback node 470 relates to the output voltage V_{BST} as follows:

$${V}_{SH} = {V}_{BST} - {I}_{SH} {R}_{SH} + {I}_{M} {R}_{SH}$$

When the boost converter circuit is in a charging state wherein an inductor is storing energy, the current I_{M} at the gain output 466 is zero and therefore the voltage V_{SH} is close to the reference voltage V_{REF} when the system is in control.

When the boost converter circuit is in a discharging state wherein an inductor is releasing energy, an inductor current I_{COIL} will flow through the measurement resistance R_{M} and a current I_{M} at the gain output 466 is not equal to zero. The product I_{M} R_{SH} acts as a feedback signal V_{FB} that can be defined as:

$${V}_{SH} = {V}_{BST} - {I}_{SH} {R}_{SH} + {g}_{M} {R}_{M} {I}_{COIL} {R}_{SH} = {V}_{BST} - {I}_{SH} {R}_{SH} + {V}_{FB}$$

The feedback signal V_{FB} is the variation on the voltage V_{SH} generated by the g_{M} stage of the gain circuit 460 in combination with the feedback resistance R_{SH} such that:

$${V}_{FB} = {I}_{M} {R}_{SH} = {g}_{M} {R}_{M} {I}_{COIL} {R}_{SH}$$

The feedback signal in the known boost converter circuit shown in FIG. 1 can be expressed as:

$${V}_{FB} = {R}_{M} {I}_{COIL}$$

In this way, the feedback circuit of FIG. 4 has introduced a gain compared to the known boost converter circuit shown of FIG. 1 equal to:

$$gain = {g}_{M} {R}_{SH}$$

The voltage controlled current source g in combination with the feedback resistance R_{SH} required to program the target output voltage creates the gain factor.

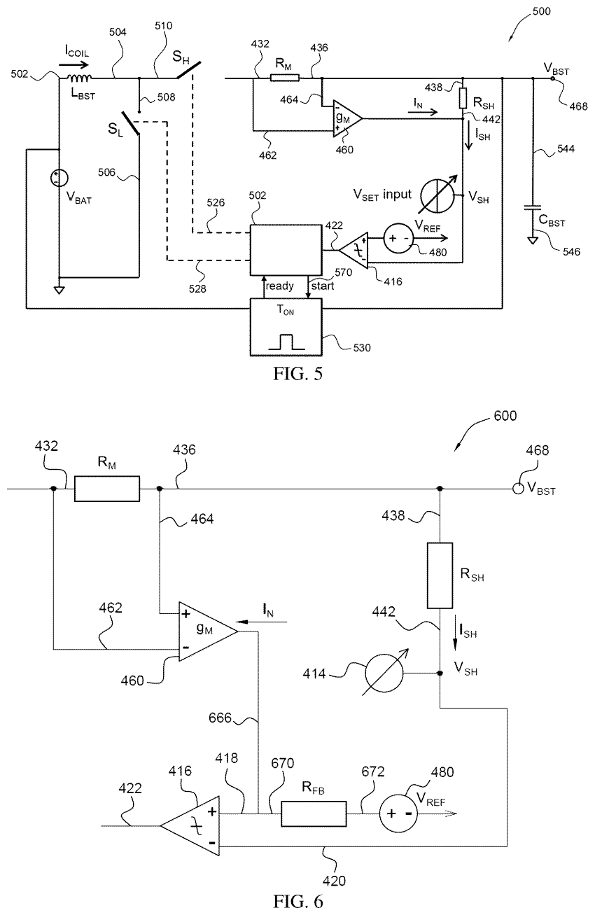

FIG. 5 shows a boost converter circuit 500 comprising the feedback circuit of FIG. 4.

The boost converter circuit 500 of FIG. 5 comprises an inductor L_{BST} connected to an input terminal receiving an input voltage V_{BAT}, which may correspond, for instance, to battery, such that an output voltage V_{BST} is provided at the output terminal 468 of the boost converter circuit based on the input voltage V_{BAT}, wherein typically V_{BST}<V_{BAT}. The boost converter circuit of FIG. 5 further comprises a switching circuit comprising switches S_{L} and S_{H}. The boost converter circuit of FIG. 5 further comprises a control circuit 502 configured to receive the comparison output 422 of the comparison circuit 416 and to generate a first control signal 526 and a second control signal 528 based on the comparison output 422 of the comparison circuit 416. The first control signal 526 is configured to control the switch S_{L} to open or close and the second control signal 528 is configured to control the switch S_{H} to open or close. Furthermore the boost converter circuit of FIG. 5 comprises a pulse signal circuit 530 configured to provide an on-time signal to the boost converter circuit based on a third control signal 570 generated by the control unit 502.

In the example of FIG. 5, the inductor L_{BST} comprises a first end 502 and a second end 504 such that the first end 502 of the inductor L_{BST} is connected to the input voltage V_{BAT} and the second end 504 of the inductor L_{BST} is connected to the switch S_{L} and to the switch S_{H}. The switch S_{L} comprises a first end 506 and a second end 508. The first end 506 of the switch S_{L} is connected to ground and the second end 508 of the switch S_{L} is connected to the second end 504 of the inductor L_{BST}. The switch S_{H} comprises a first end 510 and a second end 512. The first end 510 of the switch S_{H} is connected to the second end 504 of the inductor L_{BST} and the second end 512 of the switch S_{H} is connected to the first end 432 of the measurement resistor R_{M} and to the first gain input 462 of the voltage controlled current source 460. The switches S₁ and S₂ may be implemented with any kind of suitable switching device, for example, a transistor, a diode, etc.

As illustrated in FIG. 5, the boost converter circuit may comprise a capacitor C_{BST} having a first end 544 and a second end 546 wherein the first end 544 of the capacitor C_{BST} is connected to the output voltage V_{BST} of the boost circuit and the second end 546 of the capacitor C_{BST} is connected to ground.

The control unit 502 is configured to generate the first control signal 526 and/or the second control signal 528 in order to control the switching of S_{H} and/or S_{L} based on the comparison output 422 generated by the comparison circuit 416. The control unit 502 is also configured to generate the third control signal 570 in order to control the pulse generator circuit 530 based on the comparison output 422 generated by the comparison circuit 416.

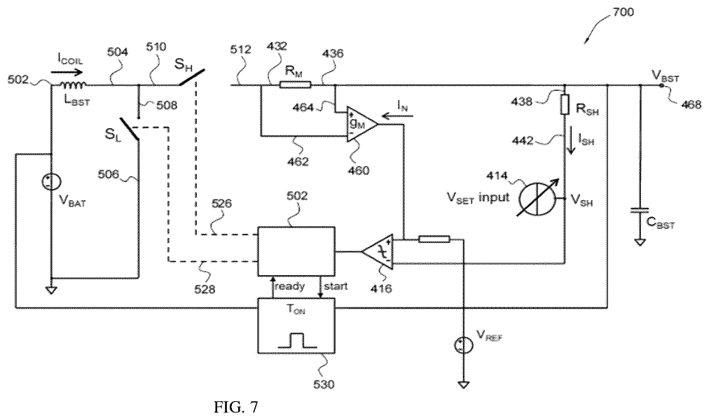

FIG. 6 shows a feedback circuit 600 according to another embodiment of the disclosure.

In FIG. 6, the same reference numbers as in FIG. 4 have been used to refer to similar elements. Furthermore, the feedback circuit 600 of FIG. 6 comprises another feedback resistance R_{FB}. The feedback resistance R_{FB} comprises a first end 670 and a second end 672 wherein the first end 670 of the feedback resistance R_{FB} is connected to the first comparison input 418 of the comparison circuit 416. The gain output 666 of the voltage controlled current source 460 is now also connected to the first comparison input 418 of the comparison circuit 416 such that a current IN is provided based on voltage sensed at the first and second gain inputs. Furthermore, the second end 672 of the feedback resistance R_{FB} is connected to the voltage source 480.

In this way, an inverse feedback voltage is added at the first comparison input 418 using the feedback resistance R_{FB}. If the feedback resistance R_{FB} has a value identical to the value of the other feedback resistance R_{SH}, the effect is identical as in the feedback circuit of FIG. 4. The advantage of the feedback circuit 600 of FIG. 6 is that the value g_{M} for the g_{M} stage of the gain circuit 460 and the value of the feedback resistance R_{FB} can be chosen independent of the value of the feedback resistance R_{SH}. However, the voltage source 480 providing V_{REF} must be able to sink the current I_{N}.

The feedback voltage in FIG. 6 can be represented as V_{FB}=g_{M}R_{M}I_{COIL}R_{FB}.

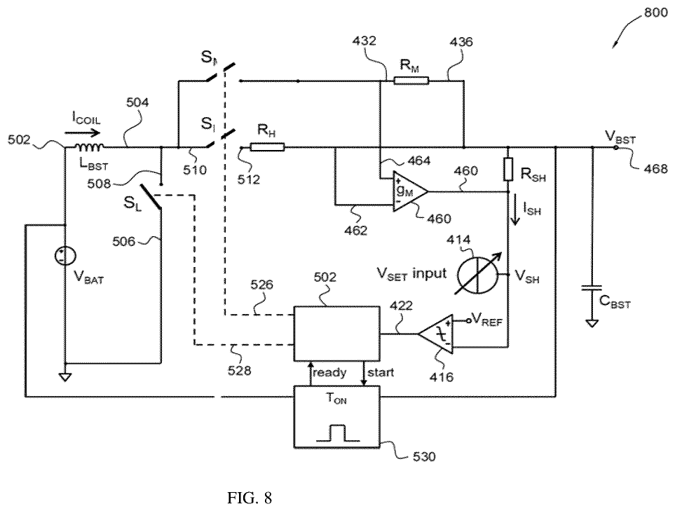

FIG. 7 shows a boost converter circuit 700 similar to the boost converter circuit 500 of FIG. 5 but comprising the feedback circuit 600 of FIG. 6. The boost converter circuit 700 of FIG. 7 also operates similar to the boost converter circuit 500 of FIG. 5 but with a feedback voltage V_{FB}=g_{M}R_{M}I_{COIL}R_{FB}.

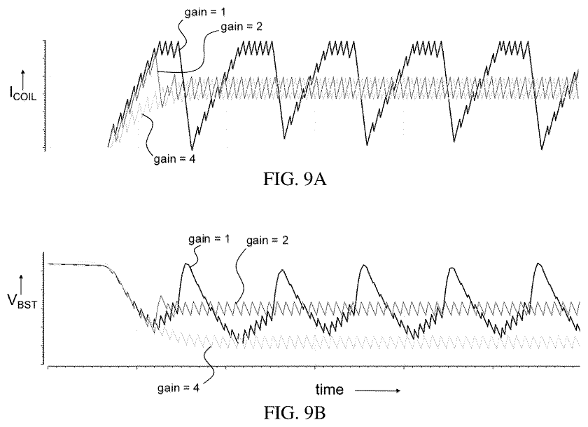

FIG. 8 shows a boost converter circuit 800 according to another embodiment of the disclosure. The boost converter circuit 800 further comprises a measurement switch S_{M} in series with the measurement resistance R_{M}. Furthermore, the measurement switch S_{M} and the measurement resistance R_{M} are connected in parallel with the switch S_{H} of the boost converter circuit 800. The switch S_{H} comprises an on-resistance R_{H} when the first switch S_{H} is closed, such that the measurement switch S_{M} and the switch S_{H} of the boost converter circuit 800 are configured to open and close at the same time. In this way, measurement resistance R_{M} is located out of the high current path avoiding loss of energy at said measurement resistance R_{M}. The on-resistance R_{H} of the switch S_{H} which is reused. The measurement switch S_{M} switches simultaneously with switch S_{H} such that the voltage across the switch S_{H} and the on-resistance R_{H} is sensed when both switches S_{H} and S_{M} are closed. The measurement resistance R_{M} can be chosen much larger so that the power loss in the measurement resistance R_{M} can be neglected. For instance, for a boost converter circuit 800 with a switch resistance R_{H} in the range of 10-100 miliohms, the measurement resistance R_{M} can be chosen in the kiloohms range. When both switches S_{H} and S_{M} are closed the voltage across the measurement resistance R_{M} is equal to

$${V}_{{R}_{M}} = {I}_{COIL} {R}_{H}$$

When both switches S_{H} and S_{M} are open, V_{BST} is sensed, so the voltage across the measurement resistance R_{M} is zero:

$${V}_{{R}_{M}} = 0$$

The boost converter circuit 800 of FIG. 8 further comprises a feedback circuit as the one shown in FIG. 5 wherein the first gain input 462 and the second gain input 464 of the gain circuit 460 are respectively connected to the second end 436 of the measurement resistance R_{M} and to the first end 432 of the measurement resistance R_{M}. The value of g_{M} can now be chosen in such a way that the output current of the g_{M} stage is higher than the current through the original capacitor C_{M} that was replaced. Therefore, the voltage step 4V at the feedback node V_{SH} can be scaled:

$$Δ V = {I}_{COIL} {R}_{H} {g}_{M} {R}_{SH}$$

For g_{M}=1/R_{SH}, a gain of 1 is achieved compared to the situation with the use of the capacitor. For higher values of g_{M}, the feedback current is higher and has the same effect as a higher measurement resistance. The feedback gain can be defined as:

$$gain = {g}_{M} {R}_{SH}$$

The stability requirement now includes the gain such that:

$$gain \frac{{R}_{SH} {C}_{BST} {V}_{BAT}}{{L}_{BST}} > {I}_{LOAD}$$

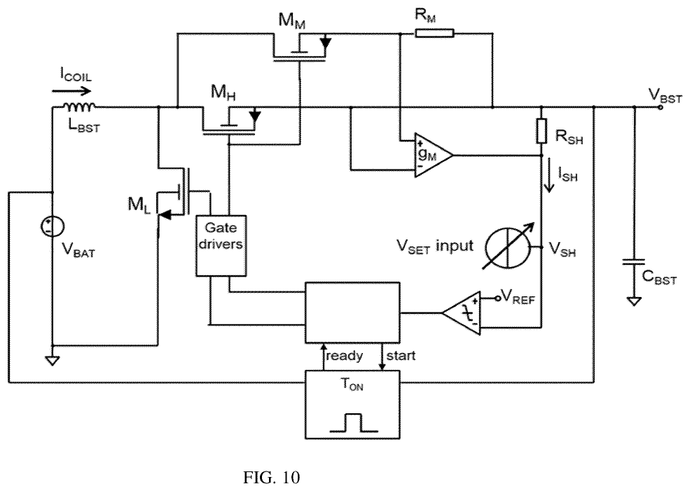

FIGS. 9A-B show time diagrams of the waveforms of several signals of the boost converter circuit 800 of FIG. 8 during operation. Specifically, FIGS. 9A-B show the values of the inductor current I_{COIL} and the output voltage V_{BST} of the boost converter circuit 800 of FIG. 8 as a function of time for three different gains, namely for gain 1, 2 and 4. For reference, the case with gain=1 is added. This resembles the prior art situation using a capacitor that hits the maximum current limit. Clearly, the feedback gain can now be used to stabilize the boost converter circuit for operating conditions that would not be possible without it. Note that the higher feedback gain setting results also in a higher output resistance in the same way as a higher measurement resistance would do because it increases the ripple voltage amplitude on the feedback node V_{SH}.

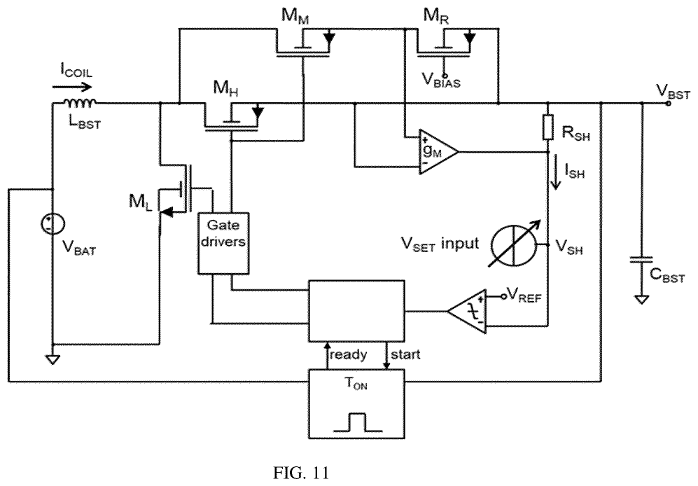

FIGS. 10 and 11 show possible implementations of the boost converter circuit 800 of FIG. 8. The switches in the boost converter circuit may be implemented with transistors. An example of a complementary power stage using NMOS and PMOS transistors can be seen in FIG. 9A where the switch S_{L} is implemented with NMOS transistor M_{L}, switch S_{H} is implemented with PMOS transistor MH and switch S_{M} is implemented with a transistor M_{M} that can be the same type of PMOS transistor as M_{H} so that the gate drive of M_{H} and M_{M} can be combined. Since M_{M} has a certain on-resistance, the voltage at the input of the g_{M} stage is a fraction of the drain-source voltage of M_{H} determined by the resistive divider formed by M_{M} and R_{M}.

R_{M} can also be implemented with a PMOS transistor M_{R} as can be seen in FIG. 11. When V_{BIAS} is equal to the gate voltage of M_{H} in on-state, M_{M} and M_{R} again form a resistive divider that determines the fraction of the voltage across M_{H} that is driving the gm stage. The advantage of this method is that this fraction is independent of process variation and temperature since the same type of components are used for switch and resistance. The same method can be used for an implementation where M_{H}, M_{M} and M_{R} are NMOS transistors (in a full NMOS power stage).

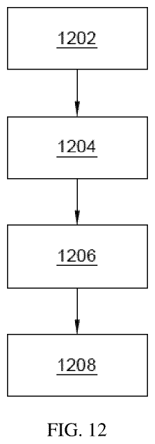

FIG. 12 shows a flowchart of a method of operating the feedback circuit for a boost converter circuit of FIG. 6. The method of FIG. 6 comprises a step 1202 of receiving, at the measurement resistance R_{M}, the current I_{COIL}. At step 2004, the method receives, at the gain circuit 460, a sensed voltage associated to the measurement resistance and proceeds to step 1206. Step 1206 comprises providing, at the gain output 466 of the gain circuit, a gain signal generated based on the sensed voltage. Finally, the method of FIG. 12 comprises a step 1208 of generating, at the comparison output 422 of the comparison circuit 416, a comparison signal, wherein the comparison signal is generated based on the gain signal, a voltage drop across the feedback resistance (R_{SH}) and a reference signal (V_{REF}).

The examples and embodiments described herein serve to illustrate rather than limit the disclosure. The person skilled in the art will be able to design alternative embodiments without departing from the scope of the claims. Reference signs placed in parentheses in the claims shall not be interpreted to limit the scope of the claims. Items described as separate entities in the claims or the description may be implemented as a single hardware or software item combining the features of the items described.

What is claimed is:

1. A feedback circuit for a boost converter circuit wherein the feedback circuit comprises:
a measurement resistance configured to receive a current;
a feedback resistance;
a gain circuit comprising a gain output and configured to receive a sensed voltage associated to the measurement resistance, and to provide, at the gain output, a gain signal generated based on the sensed voltage; and
a comparison circuit comprising a comparison output, and configured to generate a comparison signal, at the comparison output, wherein the comparison signal is generated based on the gain signal, a voltage drop across the feedback resistance and a reference signal.

2. The feedback circuit according to claim 1, wherein the measurement resistance comprises a first end and a second end, the gain circuit comprises a first gain input and a second gain input and wherein the gain circuit is configured to receive, at the first gain input, a first voltage sensed at the first end of the measurement resistance, to receive, at the second gain input, a second voltage sensed at the second end of the measurement resistance, and to provide, at the gain output, the sensed voltage generated based on the first sensed voltage and the second sensed voltage.

3. The feedback circuit according to claim 2, wherein the feedback resistance comprises a first end and a second end and wherein the first end of the feedback resistance is coupled to the second end of the measurement resistance, the second end of the feedback resistance is coupled to the comparison circuit and the gain output is coupled to the comparison circuit.

4. The feedback circuit according to claim 1, wherein the comparison circuit comprises a first comparison input, a second comparison input and a comparison output, wherein the comparison circuit is configured to receive the reference voltage at the first input, to receive a feedback signal at the second input, and to generate the comparison signal by comparing the feedback signal and the reference signal, wherein the feedback signal is based on the gain signal and the voltage drop across the feedback resistance.

5. The feedback circuit according to claim 4, wherein the gain output is coupled to the second end of the feedback resistance and to the second comparison input.

6. The feedback circuit according to claim 1, further comprising another feedback resistance configured to receive the gain signal wherein the comparison circuit comprises a first comparison input, a second comparison input and a comparison output, wherein the comparison circuit is configured to receive, at the first comparison input, the sum of the reference voltage and a further voltage drop caused by the gain signal across the another feedback resistance, to receive the voltage drop across the feedback resistance at the second comparison input and to generate the comparison signal by comparing the sum of the reference voltage and the further voltage drop with the voltage drop across the feedback resistance.

7. The feedback circuit according to claim 6, wherein the another feedback resistance comprises a first end and a second end wherein the first comparison input is coupled to the first end of the another feedback resistance and to the gain output and wherein the second end of the another feedback resistance is coupled to the reference voltage.

8. The feedback circuit according to claim 1, wherein the gain circuit comprises a voltage controlled current source.

9. The feedback circuit according to claim 1, wherein the first end of the feedback resistance is coupled to an output terminal of the boost converter.

10. The feedback circuit according to claim 1, further comprising a measurement switch wherein the measurement switch and the measurement resistance are coupled in series, wherein the measurement switch and the measurement resistance are coupled in parallel with a first switch of the boost converter, wherein the first switch comprises an on-resistance when the first switch is closed, and wherein the measurement switch and the first switch of the boost converter circuit are configured to open and close at the same time.

11. The feedback circuit according to claim 10, wherein the first switch is implemented with a first PMOS transistor and the measurement switch is implemented with a second PMOS transistor, so that a gate drive of the first PMOS transistor and the second PMOS transistor is combined.

12. The feedback circuit according to claim 11, wherein a voltage at an input of a g_{M} stage is a fraction of a drain-source voltage of the first PMOS transistor determined by a resistive divider formed by the second PMOS transistor and the measurement resistance.

13. The feedback circuit according to claim 11, wherein the measurement resistance is implemented with a third PMOS transistor, when a gate voltage of the third PMOS transistor is equal to a gate voltage of the first PMOS transistor in on-state, the second PMOS transistor and the third PMOS transistor form a resistive divider that determines a fraction of the voltage across the first PMOS transistor that is driving a gm stage.

14. The feedback circuit according to claim 1, further comprising an adjustable current source coupled to the second end of the feedback resistance and to the second comparison input of the comparison circuit.

15. The feedback circuit according to claim 1, wherein when the boost converter circuit is in a charging state, an inductor is storing energy, a current at the gain output is zero and a voltage is close to a reference voltage when a system is in control, and/or, when the boost converter circuit is in a discharging state, an inductor is releasing energy, an inductor current flows through the measurement resistance and a current at the gain output is not equal to zero.

16. A boost converter circuit comprising:
a feedback circuit for a boost converter circuit, wherein the feedback circuit comprises:
a measurement resistance configured to receive a current;
a feedback resistance;
a gain circuit comprising a gain output and configured to receive a sensed voltage associated to the measurement resistance, and to provide, at the gain output, a gain signal generated based on the sensed voltage; and
a comparison circuit comprising a comparison output, and configured to generate a comparison signal, at the comparison output, wherein the comparison signal is generated based on the gain signal, a voltage drop across the feedback resistance and a reference signal;
an inductor;
an input terminal configured to receive an input voltage;
an output terminal configured to provide an output voltage;
a control circuit configured to switch the circuit to perform cycles wherein each cycle comprises an energy discharging state in which the inductor provides energy to the output terminal and an energy charging state in which the inductor stores energy provided by the input voltage; wherein the control circuit is configured to switch the boost converter circuit based on the comparison signal.

17. The boost converter circuit of claim 16, wherein the inductor comprises a first end and a second end, wherein the first end is coupled to the input terminal, and wherein the control circuit comprises a first switch comprising a first end connected to the second end of the inductor and a second end connected to ground and wherein the first switch is configured to connect the inductor to the ground such that the inductor enters into a charging state, and to disconnect the inductor from the ground.

18. The boost converter circuit according to claim 17, wherein the switching circuit further comprises a second switch having a first end coupled to the second end of the inductor, and having a second end coupled to the output terminal and wherein the second switch is configured to couple the inductor to the output terminal such that the energy storage element enters into a discharging state.

19. A method of operating a feedback circuit for a boost converter circuit, the method comprising the steps of receiving, at a measurement resistance, a current;
receiving, at a gain circuit, a sensed voltage associated to the measurement resistance;
providing, at a gain output of the gain circuit, a gain signal generated based on the sensed voltage; and
generating, at a comparison output of a comparison circuit, a comparison signal, wherein the comparison signal is generated based on the gain signal, a voltage drop across the feedback resistance and a reference signal.

20. The method according to claim 19, wherein the feedback circuit comprises an adjustable current source coupled to a second end of the feedback resistance and to a second comparison input of the comparison circuit.
